(19) United States
(12) Patent Application Publication
(10) Pub. No.: US 2013/0204495 A1
(43) Pub. Date: Aug. 8, 2013

(54) SYSTEM AND METHOD FOR MONITORING AND REGULATING A VEHICLE

(71) Applicants: Eric L. Reed, Livonia, MI (US); Thomas Lee Miller, Ann Arbor, MI (US); Brian Bennie, Sterling Heights, MI (US)

(72) Inventors: Eric L. Reed, Livonia, MI (US); Thomas Lee Miller, Ann Arbor, MI (US); Brian Bennie, Sterling Heights, MI (US)

(73) Assignee: FORD GLOBAL TECHNOLOGIES, LLC, Dearborn, MI (US)

(21) Appl. No.: 13/364,720

(22) Filed: Feb. 2, 2012

(51) Int. Cl. G06F 19/00; G05D 13/00

(52) U.S. Cl. 701/45; 701/36

(57) ABSTRACT

A system and method for monitoring and regulating a vehicle includes a communications device to provide remote communication with the vehicle, and a vehicle restriction control module for monitoring and regulating at least one vehicle operation parameter. The vehicle restriction control module is in communication with the communications device and is programmable by an authorized user when accessed by an embedded security code to receive restriction instructions in accordance with a driving restriction imposed on a driver by the authorized user. The system provides information about the at least one vehicle operation parameter to the authorized user.

### FIELD OF THE INVENTION

The present invention generally relates to monitoring and regulating an automotive vehicle, and more particularly to programming a control module of the vehicle with restriction instructions in accordance with a driving restriction imposed on a driver.

### BACKGROUND OF THE INVENTION

Drivers with poor driving records are often penalized by police and judicial agencies by having restrictions placed on their driver's license. Driving restrictions are common and may include revocation of a driver's license for a particular length of time or some form of restriction on the driver's operation of the vehicle. For example, traffic violators may face speed restrictions, restrictions on the hours in which the driver may operate the vehicle, and restrictions on the routes that the driver may take when driving. Similarly, parents may choose to authorize similar such restrictions on their children by allowing them to operate the vehicle only under limited conditions.

Generally, violation of legal restrictions is only exposed when the driver with a restricted license is stopped by a police officer for an observed traffic violation. Thus, enforcement of a driving restriction is difficult, if not impossible, and does not provide monitoring of the vehicle's operation.

### SUMMARY OF THE INVENTION

According to one aspect of the present invention, a system for monitoring and regulating a vehicle is provided. The system includes a communications device to provide remote communication with the vehicle, and a vehicle restriction control module for monitoring and regulating at least one vehicle operation parameter. The vehicle restriction control module is in communication with the communications device and is programmable by an authorized user when accessed by an embedded security code to receive restriction instructions in accordance with a driving restriction imposed on a driver by the authorized user. The system provides information about the at least one vehicle operation parameter to the authorized user.

According to another aspect of the present invention, a method for monitoring and regulating a vehicle is provided. The method includes the steps of providing a security code for an authorized user, accessing a vehicle restriction control module with the security code, and programming the vehicle restriction control module with restriction instructions in accordance with a driving restriction imposed on a driver by the authorized user. The method further includes monitoring and regulating at least one vehicle operation parameter, and providing information about the at least one vehicle operation parameter to the authorized user.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a schematic representation of a system for monitoring and regulating a vehicle according to one embodiment;

FIG. 2 is a flow diagram illustrating a method for monitoring and regulating a vehicle according to one embodiment;

FIG. 3 is a flow diagram illustrating an exemplary method for monitoring and regulating the speed of the vehicle;

FIG. 4 is a flow diagram illustrating an exemplary method for monitoring for and regulating impaired driving of the vehicle;

FIG. 5 is a flow diagram illustrating an exemplary method for monitoring and regulating the time the vehicle is being driven; and

FIG. 6 is a flow diagram illustrating an exemplary method for monitoring and regulating the geographic range the vehicle is being driven.

### DETAILED DESCRIPTION OF THE PREFERRED EMBODIMENTS

It is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

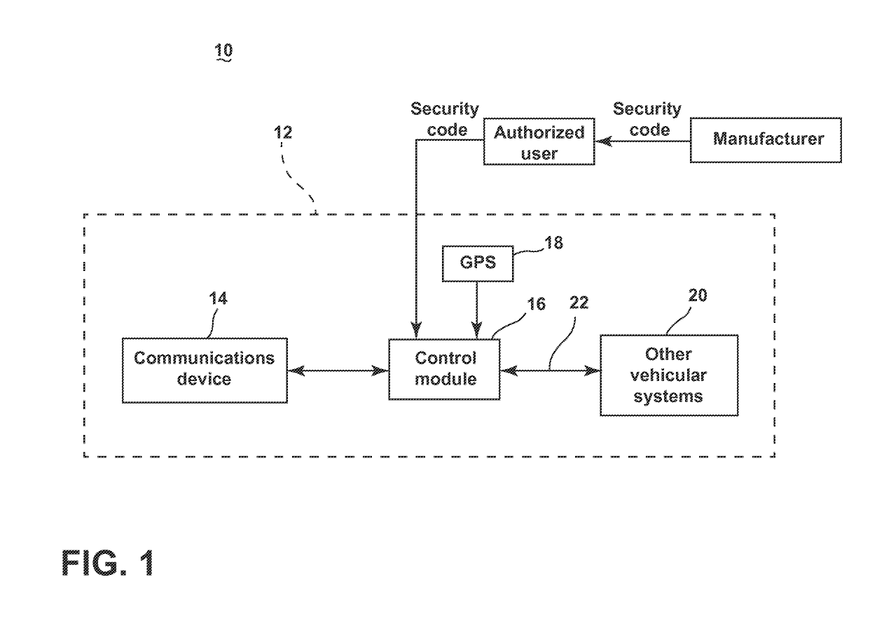

Referring to FIG. 1, reference numeral 10 generally designates a system for monitoring and regulating a vehicle 12. The system 10 comprises a communications device 14 and a vehicle restriction control module 16. The communications device 14 enables telecommunication with the system 10, and may be in the form of a cellular telephone transceiver, a telematics system integral to the vehicle 12, or any other suitable device(s) for providing remote wireless communication with the system 10. The vehicle restriction control module 16 monitors and regulates at least one vehicle operation parameter and is in communication with the communications device 14. The control module 16 includes control circuitry such as a microprocessor or ASIC capable of monitoring and regulating vehicle operation parameters and communicating with the communications device 14. The control module 16 generally also includes memory for storing data, can process the data and one or more routines to perform steps of a method, and can affect control of other vehicular systems 20 through electronic communication with a vehicle electrical system 22. The control module 16, communications device 14, vehicular systems 20, and the vehicle's electrical system 22 are in electronic communication with one another, and may be wired or in wireless electronic communication.

The system 10 further comprises a global positioning system device (GPS) 18 for providing vehicle location information such as latitude and longitude position coordinates. GPS 18 is widely used to provide highly accurate positional information using satellite signals. The GPS 18 is also in wired or wireless electronic communication with the control module 16, and provides the vehicle's current location to the control module 16.

The vehicle restriction control module 16 is programmable by an authorized user (AU) when accessed by an embedded security code (SC). The authorized user (AU) is a person or agency that is authorized to impose some form of restriction over a driver of the vehicle 12. Examples of authorized users (AU) include parents of a young driver, law enforcement police agencies or officers, judicial agencies or officers, or any other individual or organization that has a right to impose restrictions on the driver. The security code (SC) may be generated by the vehicle's original equipment manufacturer (OEM) or the manufacturer of the control module 16 and is embedded within the normally locked control module 16. Additionally, it should be noted that the security code (SC) is generated by the OEM, manufacturer of the control module 16, or any other manufacturer at the OEM's request, therefore providing a greater level of security to the system 10. The security code (SC) can subsequently be provided to the authorized user (AU) and used to access the control module 16 to allow programming thereof.

The vehicle restriction control module 16 contains software that is programmable to receive restriction instructions (RI) from the authorized user (AU). The restriction instructions (RI) are in accordance with a driving restriction imposed upon the driver by the authorized user (AU) and are related to vehicle operation parameters. Non-limiting examples of driving restrictions include limitations related to the vehicle operation parameters of speed, time of day, geographic location or range, and impaired driving. For example, a maximum driving speed restriction may be imposed upon the driver, and restriction instructions (RI) related to a driving speed restriction can be programmed into the control module 16 and then monitored and/or regulated.

Additionally, the vehicle restriction control module 16 can provide information about the vehicle operation parameter(s) to the authorized user (AU). The information is communicated to the authorized user (AU) via the communications device 14 and information may be obtained by the control module 16 through electronic communication with the vehicular systems 20, devices, or sensors, such as a clock, the GPS 18, a speedometer, and other control and monitoring systems, devices, and sensors commonly used on automotive vehicles 12.

When the vehicle restriction control module 16 determines that one of the driving restrictions and related restricted vehicle operation parameters has been violated, the control module 16 may activate one of several warnings or actions. Examples of such warnings include audio and visual warnings, such as sounding a horn and activating hazard lights. These warning are intended to induce the driver to stop violating the driving restriction. The control module 16 communicates to the vehicular systems 20, which in turn initiate some form of action on the vehicle 12. Examples of such actions include automatically limiting or reducing the speed of the vehicle 12, and inhibiting the vehicle 12 start. Additionally, the control module 16, using the communications device 14, can notify the authorized user (AU) of the violation. These actions are intended to reduce or prevent continuation of the violation.

It should be noted that the vehicle restriction control module 16 may be integral to the vehicle 12 as manufactured by the OEM, or may be a separate device that is installed on the vehicle 12 post manufacture, as an after-market component. In either situation, the control module 16 is in electronic communication with the vehicle electrical system 22 and other vehicular systems 20.

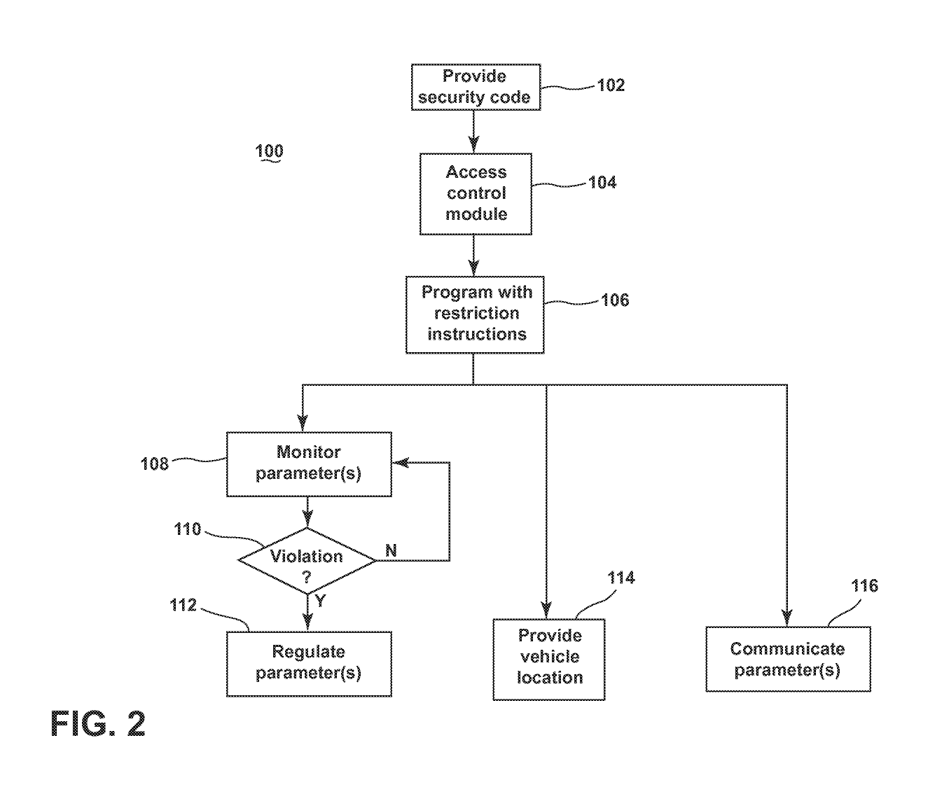

Utilizing the system 10 described above, it is possible to monitor and regulate the vehicle 12. According to one embodiment illustrated in FIG. 2, a method 100 for monitoring and regulating the vehicle 12 begins at step 102 where the security code (SC) is provided to the authorized user (AU). In step 104, the authorized user (AU) uses the security code (SC) to access the vehicle restriction control module 16, and at step 106, the authorized user (AU) programs the vehicle restriction control module 16 with restriction instructions (RI) in accordance with the particular driving restriction(s) imposed upon the driver by the authorized user (AU). In step 108 the restricted vehicle operation parameter(s) are monitored and regulated. The particular vehicle operation parameter(s) that are monitored correspond to the driver's specific driving restrictions.

The method 100 continues with a determination step 110 where the vehicle restriction control module 16 determines whether the driving restriction and related vehicle operation parameter has been violated. If the vehicle operation parameter has not been violated, the method 100 cycles back to step 108, monitoring the restricted parameter(s). If, in determination step 110, the control module 16 determines that the vehicle operation parameter has been violated, the method 100 continues to at least one of steps 112-116. In step 112, the control module 16 affects control over one of the vehicle operation parameters by regulating that parameter. The control module 16 may regulate the parameter by communicating to the other vehicular systems 20, which in turn can initiate a restrictive action as controlled by the particular vehicular system 20. The method 100 may also use the GPS 18 to provide the location of the vehicle 12 to the authorized user (AU), as in step 114, and may communicate the violated vehicle operation parameter(s) to the authorized user (AU), as in step 116. Steps 114 and 116 communicate information about the vehicle 12 to the authorized user (AU), such that the authorized user (AU) can monitor the vehicle 12 and/or travel to the vehicle's 12 current location, if desired.

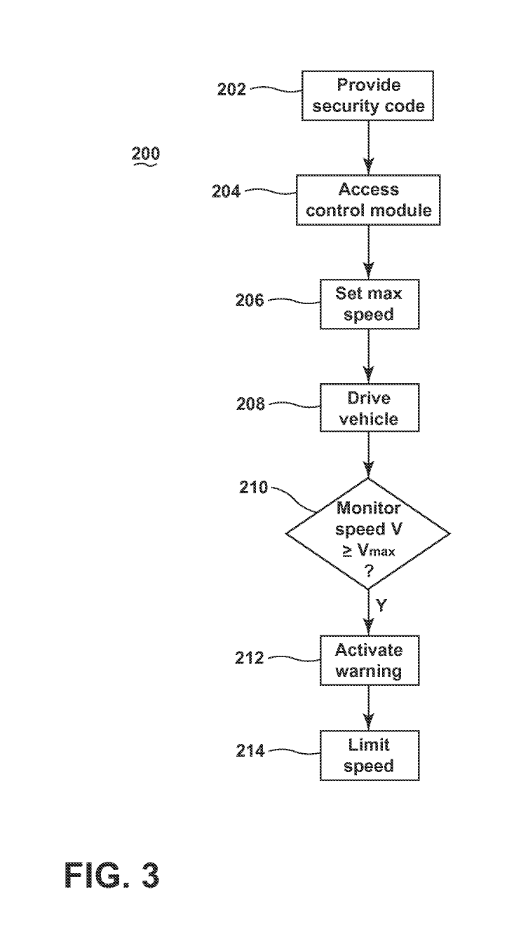

FIGS. 3-6 illustrate specific, non-limiting examples of methods for monitoring and regulating driving restrictions and vehicle operation parameters. In one example, illustrated in FIG. 3, a method 200 is used to monitor and regulate the speed (V) at which the driver is currently driving the vehicle 12. In this example, the authorized user (AU) is imposing a speed restriction on the driver. The method 200 begins at step 202 where the security code (SC) is provided to the authorized user (AU). In step 204, the authorized user (AU) uses the security code (SC) to access the vehicle restriction control module 16, and at step 206, the authorized user (AU) programs the control module 16 with restriction instructions (RI) in accordance with the speed restriction to set a maximum driving speed (Vₘₐₓ). In step 208 the vehicle 12 is driven, and step 210 monitors the speed (V) and compares it relative to the set maximum driving speed (Vₘₐₓ). If the speed restriction is violated because the current vehicle 12 speed exceeds the maximum driving speed (Vₘₐₓ), the method 200 progresses to step 212, in which a warning is activated. The warning may include an audio and/or visual message to the driver stating that the maximum driving speed (Vₘₐₓ) has been exceeded. Additionally, before the vehicle speed (V) actually reaches the maximum driving speed (Vₘₐₓ), the system 10 may activate a precursory warning, advising the driver that the maximum driving speed (Vₘₐₓ) is being approached. From step 212, the method continues to step 214, where the vehicle's 12 speed (V) is automatically limited. To initiate the restrictive action in step 212, the control module 16 can communication with one of the vehicular systems 20, such as the powertrain, or any other vehicular system, control, or device that can control the speed (V) of the vehicle 12. It should be noted that the warning step 212 could be considered optional, and could be eliminated from the method 200, according to one embodiment.

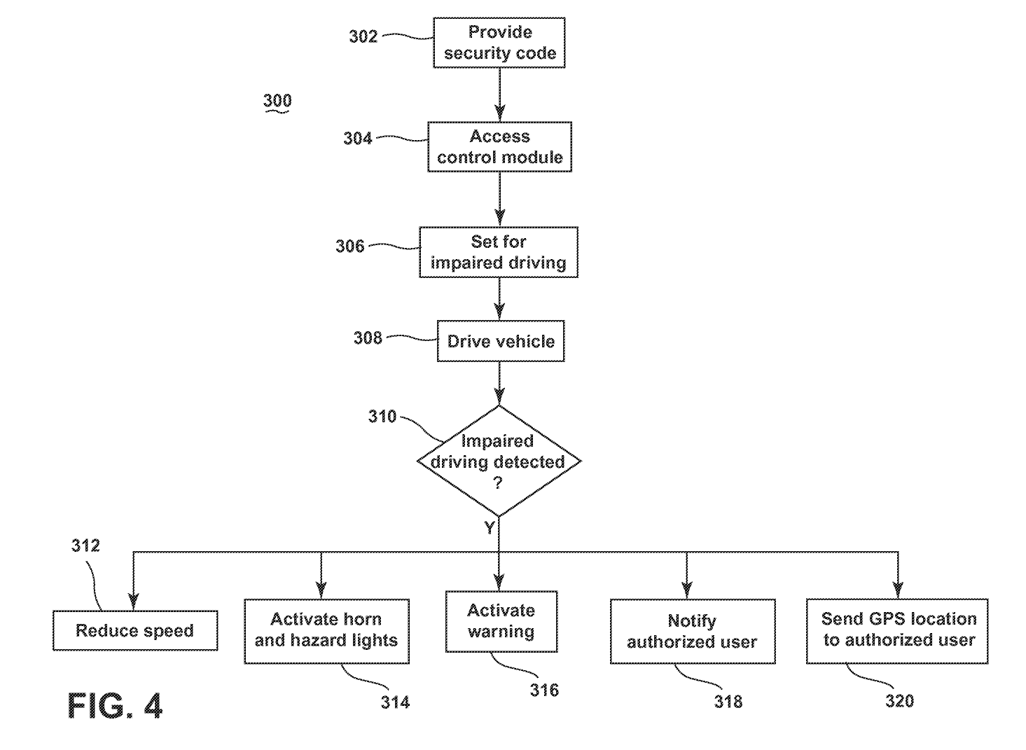

Another example, illustrated in FIG. 4, is a method 300 used to monitor and regulate impaired or erratic driving. In this example, the authorized user (AU) is imposing an erratic driving restriction on the driver. The method 300 begins at step 302 where the security code (SC) is provided to the authorized user (AU). In step 304, the authorized user (AU) uses the security code (SC) to access the vehicle restriction control module 16, and at step 306, the authorized user (AU) programs the control module 16 with restriction instructions (RI) in accordance with the erratic driving restriction. The control module 16 is in communication with other vehicular systems 20, such as a driver impairment monitor, lane departure detector, a front-looking camera, or other suitable system, control, or device for detecting impaired or erratic driving. In step 308, the vehicle 12 is driven, and step 310 detects the violation of the erratic driving restriction, after which one or more of steps 312-320 can be taken. Step 312 automatically reduces the speed (V) of the vehicle 12. The reduction of speed (V) can be gradual, and may be reduced to zero or near zero. Step 314 sounds the horn and activates the hazard lights. Step 316 provides a warning to the driver; the warning may include an audio and/or visual message to the driver stating that impaired or erratic driving has been detected. In step 318, the authorized user (AU) is notified that the erratic driving restriction has been violated, and step 320 provides the location of the vehicle 12 to the authorized user (AU). It should be easily understood that one or more of steps 312-320 can be taken, and that they do not necessarily need to occur in any particular order.

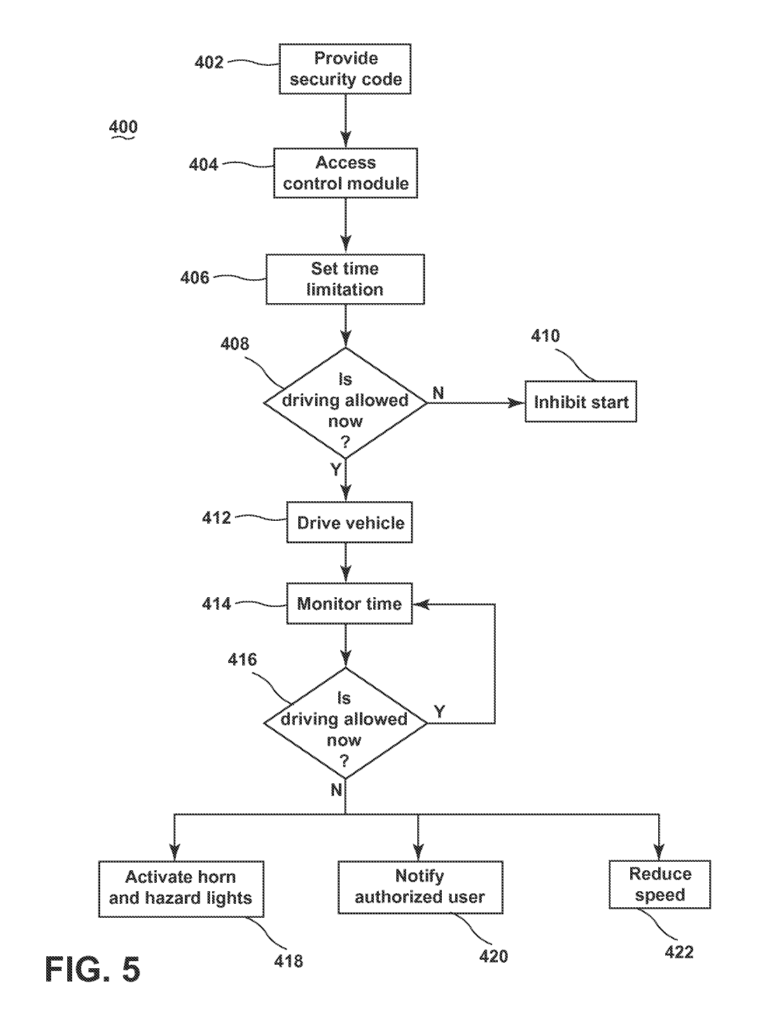

Referring now to FIG. 5, yet another example depicts a method 400 used to limit operation of the vehicle 12 to within a certain time frame. In this example, the authorized user (AU) is imposing a time driving restriction on the driver. The method 400 begins at step 402 where the security code (SC) is provided to the authorized user (AU). In step 404, the authorized user (AU) uses the security code (SC) to access the vehicle restriction control module 16, and at step 406, the authorized user (AU) programs the control module 16 with restriction instructions (RI) in accordance with the time restriction to limit the operation of the vehicle 12 to a specific time frame, for example 7 am to 6 pm on Monday-Friday. In this example, the control module 16 may be in communication with another vehicular system 20, such as a clock included in automotive vehicles. According to one embodiment, time of day may be acquired from the GPS 18 data. Step 408 determines whether driving is presently allowed, by comparing the current time to the acceptable time frame established in step 406. If driving is not presently allowed, the method 400 proceeds to step 410, which inhibits the start of the vehicle 12. As such, the control module 16 may also be in communication with another vehicular system 20, such as the ignition system, or other suitable system, device, or control that can prevent the vehicle 12 from being started.

If driving is presently allowed, the method 400 proceeds to step 412, in which the vehicle 12 is driven, and step 414, which monitors the time while the vehicle 12 is being driven. Step 416 determines whether driving is presently allowed. If, during driving, the system 10 determines that the present time is no longer within the allowable time frame and the time restriction is violated such that driving is now not allowed, the method 400 proceeds to at least one of steps 418-422. Step 418 sounds the horn and activates the hazard lights. In step 420, the authorized user (AU) is notified that the time restriction has been violated, and step 422 automatically reduces the speed (V) of the vehicle 12. The reduction of speed (V) can be gradual, and can be reduced to zero or near zero. It should be easily understood that one or more of steps 418-422 can be taken, and that they do not necessarily need to occur in any particular order.

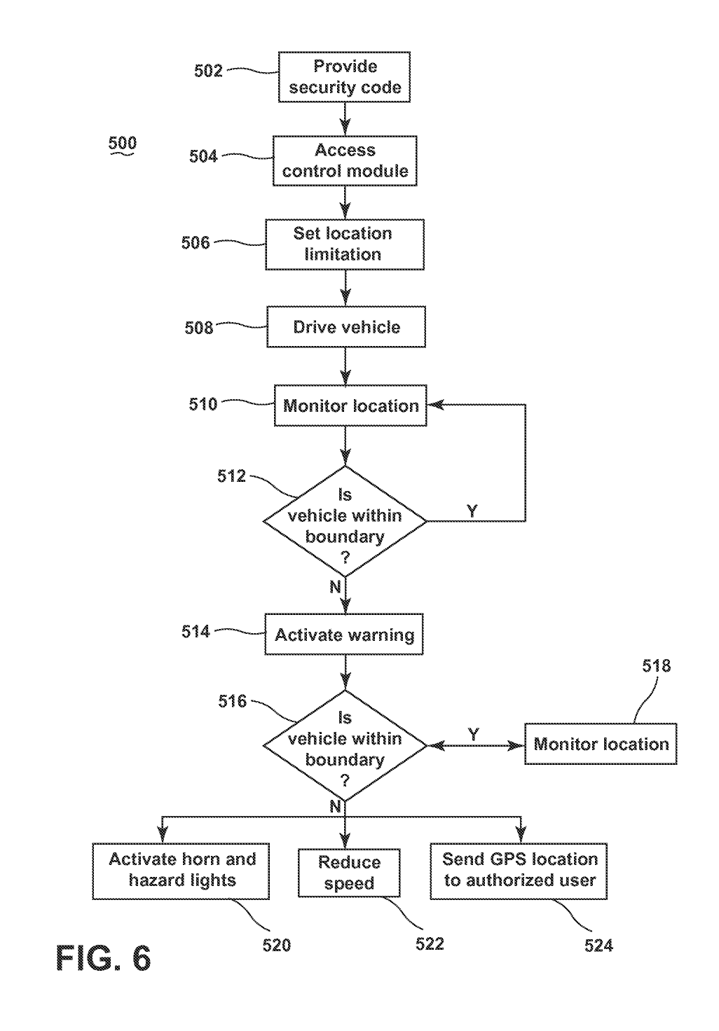

Referring now to FIG. 6, yet another example depicts a method 500 used to limit operation of the vehicle 12 to within a certain geometric range, area, location, or route. In this example, the authorized user (AU) is imposing a range restriction on the driver. The method 500 begins at step 502 where the security code (SC) is provided to the authorized user (AU). In step 504, the authorized user (AU) uses the security code (SC) to access the vehicle restriction control module 16, and at step 506, the authorized user (AU) programs the control module 16 with restriction instructions (RI) in accordance with the range restriction to limit the operation of the vehicle 12 to a specific range, for example a set route between the driver's home and work. In this example, the control module 16 may be in communication with the GPS 18, which provides the vehicle 12 location. In step 508, the vehicle 12 is driven, and in step 510, the location of the vehicle 12 is monitored. Step 512 determines whether the vehicle 12 is presently within the allowable range. If vehicle 12 is within the allowable range, the location of the vehicle 12 continues to be monitored as the vehicle 12 is driven, as in step 510.

If the vehicle 12 is not presently within the allowable range and the restriction is violated, the method 500 continues to step 514, which provides a warning to the driver. The warning may include an audio and/or visual message to the driver stating that the vehicle 12 is outside the allowable range. Step 516 determines whether the vehicle 12 has returned to the allowable range. If it is determined that the vehicle 12 has returned to within the allowable range, the present location of the vehicle 12 is then monitored, as in step 518.

If the vehicle 12 continues to be driven outside the allowable range, the method 500 proceeds to at least one of steps 520-524. Step 508 sounds the horn and activates the hazard lights. In step 522, the speed (V) of the vehicle 12 is automatically reduced. The reduction of speed (V) can be gradual, and can be reduced to zero or near zero. Step 524 provides the location of the vehicle 12 to the authorized user (AU). It should be easily understood that one or more of steps 520-524 can be taken, and that they do not necessarily need to occur in any particular order.

One of the benefits of the system 10 and methods described herein is the ability to utilize the automatic controls of the vehicular system 20 that are currently employed on automotive vehicles 12 to automatically monitor and regulate the vehicle 12 according to driving restrictions placed on a driver. The vehicular systems 20 of currently sold vehicles often provide status and sensor information via the vehicle's electrical system 22, and as a result, these vehicular systems 20 can be utilized beyond their initial intentions to provide information to the system 10 and methods to monitor and regulate the vehicle 12. The system 10 and methods advantageously enable enforcement, or at least monitoring, of driving restrictions and provide warnings intended for the safety or convenience of the driver.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A system for monitoring and regulating a vehicle, the system comprising:
a communications device to provide remote communication with the vehicle; and
a vehicle restriction control module for monitoring and regulating at least one vehicle operation parameter and in communication with the communications device;
wherein the vehicle restriction control module is programmable by an authorized user when accessed by an embedded security code to receive restriction instructions in accordance with a driving restriction imposed on a driver by the authorized user, and to provide information about the at least one vehicle operation parameter to the authorized user.

2. The system of claim 1 wherein the embedded security code is generated by a manufacturer and subsequently provided to the authorized user.

3. The system of claim 1, further comprising a global positioning system device for providing vehicle location information and in communication with the vehicle restriction control module.

4. The system of claim 3 wherein a restricted vehicle operation parameter comprises at least one of speed, impaired driving, time, and range.

5. The system of claim 4 wherein the vehicle restriction control module activates at least one of an audio and visual warning to the driver when the restricted vehicle operation parameter is violated.

6. The system of claim 5 wherein the audio warning is sounding a horn and the visual warning is activating hazard lights.

7. The system of claim 4 wherein the vehicle restriction control module automatically limits the speed of the vehicle when the restricted vehicle operation parameter is violated.

8. The system of claim 4 wherein the vehicle restriction control module notifies the authorized user when the restricted vehicle operation parameter is violated.

9. The system of claim 4 wherein the vehicle restriction control module inhibits the vehicle start when the restricted vehicle operation parameter is violated.

10. The system of claim 4 wherein the vehicle restriction control module automatically reduces the speed of the vehicle when the restricted vehicle operation parameter is violated.

11. A method for monitoring and regulating a vehicle comprising:
providing a security code for an authorized user;
accessing a vehicle restriction control module with the security code;
programming the vehicle restriction control module with restriction instructions in accordance with a driving restriction imposed on a driver by the authorized user;
monitoring and regulating at least one vehicle operation parameter; and
providing information about the at least one vehicle operation parameter to the authorized user.

12. The method of claim 11, further comprising the step of providing vehicle location information from a global positioning system device which is in communication with the vehicle restriction control module.

13. The method of claim 11 wherein a restricted vehicle operation parameter comprises at least one of speed, impaired driving, time, and range.

14. The method of claim 13, further comprising the step of activating at least one of an audio and visual warning to the driver when the restricted vehicle operation parameter is violated.

15. The method of claim 14 wherein the audio warning is sounding a horn and the visual warning is activating hazard lights.

16. The method of claim 13, further comprising the step of automatically limiting the speed of the vehicle when the restricted vehicle operation parameter is violated.

17. The method of claim 13, further comprising the step of notifying the authorized user when the restricted vehicle operation parameter is violated.

18. The method of claim 13, further comprising the step inhibiting the vehicle start when the restricted vehicle operation parameter is violated.

19. The method of claim 13, further comprising the step of automatically reducing the speed of the vehicle when the restricted vehicle operation parameter is violated.

20. A system for monitoring and regulating a vehicle, the system comprising:
a communications device to provide remote communication with the vehicle; and
a vehicle restriction control module for monitoring and regulating a vehicle operation parameter and in communication with the communications device;
wherein the vehicle restriction control module is programmable by an authorized user when accessed by an embedded security code to provide information about the vehicle operation parameter to the authorized user.
